(19) United States
(12) Patent Application Publication
(10) Pub. No.: US 2010/0089022 A1
(43) Pub. Date: Apr. 15, 2010

(54) METHOD AND APPARATUS OF FUEL NOZZLE DILUENT INTRODUCTION

(75) Inventors: Jesse Ellis Barton, Simpsonville, SC (US); Jonathan Dwight Berry, Simpsonville, SC (US); Mark Allan Hadley, Greer, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/251,050

(22) Filed: Oct. 14, 2008

(51) Int. Cl. F02C 3/30

(52) U.S. Cl. 60/39.53; 60/775

(57) ABSTRACT

Disclosed is a combustor including a baffle plate having at least one through baffle hole and at least one fuel nozzle extending through the at least one baffle hole. A shroud is disposed between the baffle plate and the at least one fuel nozzle and is affixed to the baffle plate. A plurality of openings in the shroud are configured to meter a flow of diluent between the baffle hole and the at least one fuel nozzle. Further disclosed is a method for providing diluent to a combustor including providing a plurality of openings disposed in a shroud affixed to a baffle plate and disposed between the baffle plate and at least one fuel nozzle extending through a through hole in the baffle plate. The diluent is flowed through the plurality of openings toward at least one airflow opening in the at least one fuel nozzle.

### BACKGROUND OF THE INVENTION

The subject invention relates generally to combustors. More particularly, the subject invention relates to the introduction of diluent flow into a combustor via a fuel nozzle.

Combustors typically include one or more fuel nozzles that introduce a fuel or a mixture of fuel and air to a combustion chamber where it is ignited. In some combustors, the fuel nozzles extend through holes disposed in a baffle plate of the combustor. In these combustors, it is often advantageous to introduce a volume of diluent, often nitrogen or steam, to the combustor to reduce NOₓ emissions and/or augment output of the combustor. The diluent is urged from a chamber through a gap between the baffle plate and each fuel nozzle, and then flows along a periphery of the fuel nozzle where a portion of the diluent enters the fuel nozzle via holes in the air collar of the fuel nozzle. The gaps between the baffle plate and the fuel nozzles, however, vary due to assembly tolerance stack-ups between the baffle plate and the fuel nozzles. The gap variation results in variation in diluent flow around each nozzle and throughout the combustor assembly. Further, an axial distance between the gap and the air collar holes in the fuel nozzle allow diluent to reach the combustion reaction zone without passing through the fuel nozzle and mixing directly with the fuel and air. Both of these effects reduce diluent efficiency and therefore a greater volume of diluent is required to achieve an equivalent amount of diluent flow into the fuel nozzle. The excess diluent that flows along the fuel nozzle and leads to operability problems in the combustor such as dynamics and lean blow out.

### BRIEF DESCRIPTION OF THE INVENTION

According to one aspect of the invention, a combustor includes a baffle plate including at least one through baffle hole and at least one fuel nozzle extending through the at least one baffle hole. A shroud is disposed between the baffle plate and the at least one fuel nozzle and is affixed to the baffle plate. A plurality of openings in the shroud are configured to meter a flow of diluent between the baffle hole and the at least one fuel nozzle.

According to another aspect of the invention, a method for providing diluent to a combustor includes providing a plurality of openings disposed in a shroud affixed to a baffle plate and disposed between the baffle plate and at least one fuel nozzle extending through a through hole in the baffle plate. The diluent is flowed through the plurality of openings toward at least one airflow opening in the at least one fuel nozzle.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a cross-sectional view of an embodiment of a combustor;

FIG. 2 is an end view of an embodiment of a baffle plate assembly of a combustor;

FIG. 3 is a cross-sectional view of an embodiment of the baffle plate assembly of FIG. 2; and

FIG. 4 is an embodiment of a cover ring that supplies diluent to a plenum defined by the baffle plate assembly of FIG. 2.

The detailed description explains embodiments of the invention, together with advantages and features, by way of example with reference to the drawings.

### DETAILED DESCRIPTION OF THE INVENTION

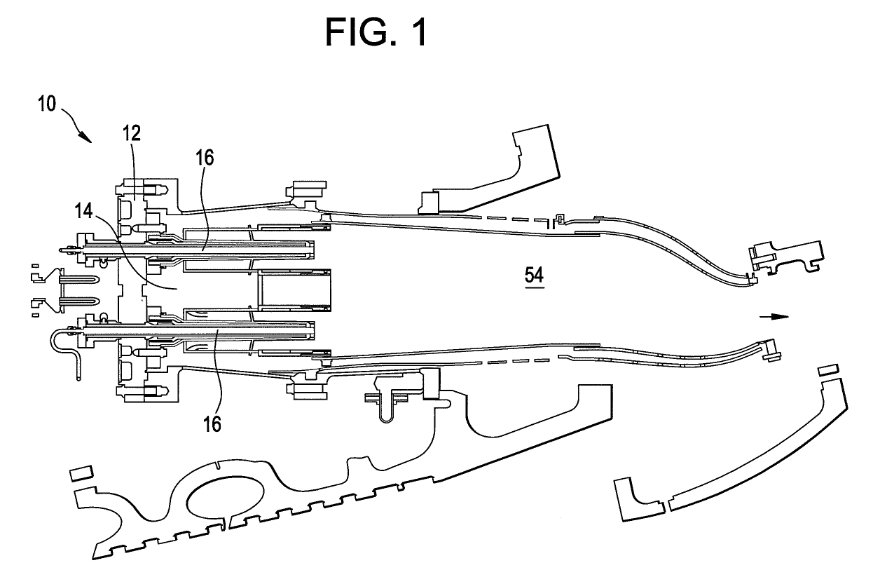

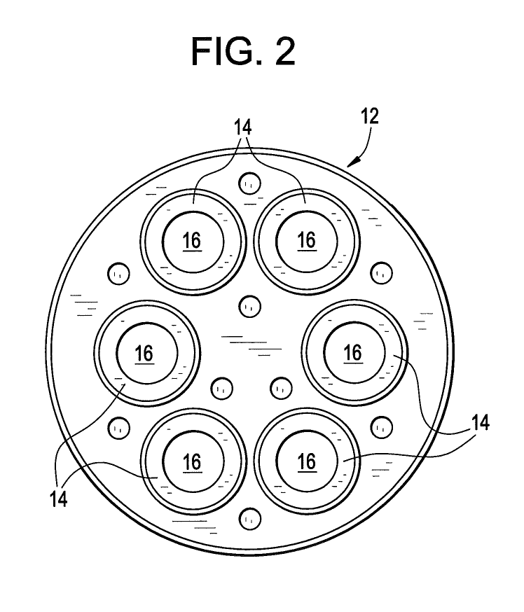

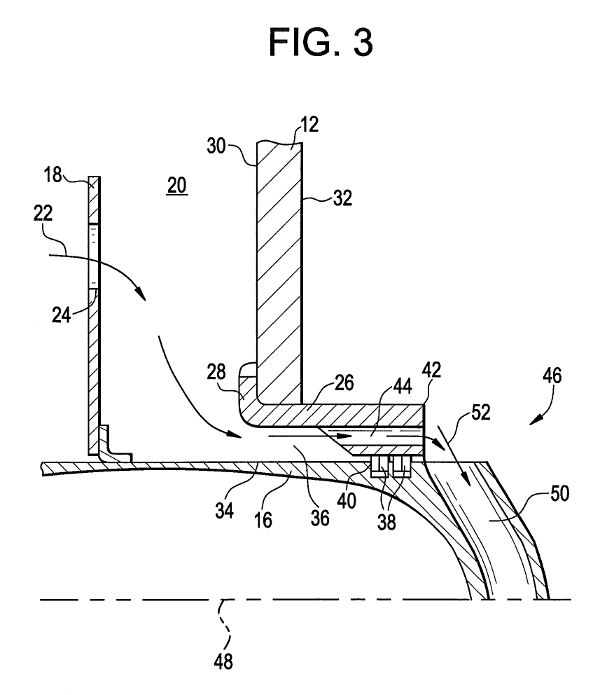

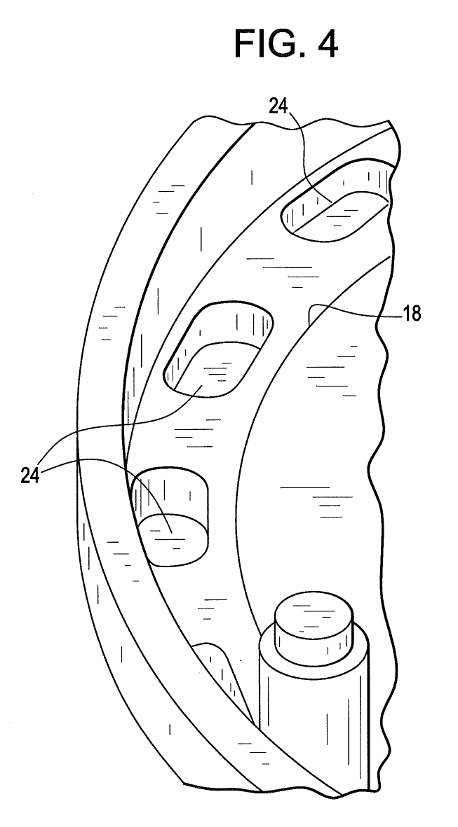

Shown in FIG. 1 is a combustor 10. The combustor 10 includes a baffle plate 12 having six baffle holes 14, through which six fuel nozzles 16 extend, for example, one fuel nozzle 16 extending through each baffle hole 14, as best shown in FIG. 2. While six fuel nozzles 16 are shown in FIG. 2, it is to be appreciated that other quantities of fuel nozzles 16, for example, one fuel nozzle 16 or four fuel nozzles 16, may be utilized. As shown in FIG. 3, the baffle plate 12 and a cover ring 18 define a plenum 20 into which a diluent flow 22 is guided via an array of orifices 24 (best shown in FIG. 4) in the cover ring 18. In some embodiments, the diluent flow 22 may comprise steam, or other diluents such as nitrogen.

At each fuel nozzle 16, as shown in FIG. 3, a shroud 26 is disposed at the baffle hole 14 between the baffle plate 12 and the fuel nozzle 16. In the embodiment of FIG. 3, the shroud 26 includes an attachment flange 28 disposed at, for example, an upstream face 30 of the baffle plate 12. In some embodiments, the attachment flange 28 is secured to the upstream face 30 by welding, but other means may be used such as mechanical fasteners, brazing, or adhesives. Further, it is to be appreciated that the shroud 26 may be secured to other portions of the baffle plate 12, for example a downstream face 32. The shroud 26 and an outer surface 34 of the fuel nozzle 16 define a flow channel 36 therebetween. Two piston rings 38 are disposed at the shroud 26 to seal between the shroud 26 and the fuel nozzle 16. As shown in FIG. 3, each piston ring 38 is disposed in a piston ring slot 40 at a tip end 42 of the shroud 26. It will be appreciated that while two piston rings 38 and two piston ring slots 40 are shown in FIG. 3, other quantities of piston rings 38 per piston ring slot 40 and quantities of slots 40 may be utilized. For example, two or three piston rings 38 may be disposed in each piston ring slot 40 and/or one or three piston ring slots 40 may be utilized. A plurality of injection holes 44 extend, through the shroud 26 from the flow channel 36 to an exterior 46 of the baffle plate 12 at a head end of the combustor. The plurality of injection holes 44 may be directed at an angle to a nozzle central axis 48 or, as shown in FIG. 3, may be substantially parallel to the nozzle central axis 48.

In operation, the diluent flow 22 is guided from the plenum 20, along the flow channel 36 and through the plurality of injection holes 44. Upon exiting the plurality of injection holes 44, at least a portion of the diluent flow 22 enters a plurality of airflow openings 50 in the fuel nozzle 16. In some embodiments, the diluent flow 22 entering the plurality of airflow openings 50 is mixed with an airflow 52 entering the plurality of airflow openings 50.

Sealing between the baffle plate 12 and the fuel nozzle 16 via at least one piston ring 38 and guiding the diluent flow 22 through the plurality of injection openings 44 allows injection of the diluent flow 22 nearby the air flow openings 50 to increase efficiency of the diluent flow 22. Further, the diluent flow 22 is metered via the injection openings 44 and consistent for each baffle hole 14 in the baffle plate 12. Thus, a volume of diluent flow 22 required is reduced thereby reducing operability issues such as dynamics and lean blow out.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor comprising:
a baffle plate including at least one through baffle hole;
at least one fuel nozzle extending through the at least one through baffle hole;
a shroud disposed between the baffle plate and the at least one fuel nozzle, the shroud affixed to the baffle plate;
a plurality of openings in the shroud configured to meter a flow of diluent between the baffle plate and the at least one fuel nozzle.

2. The combustor of claim 1 wherein at least one piston ring seals between the shroud and the at least one fuel nozzle.

3. The combustor of claim 2 wherein the at least one piston ring is disposed in at least one piston ring slot.

4. The combustor of claim 2 wherein the at least one piston ring is two piston rings.

5. The combustor of claim 4 wherein the shroud is secured to the baffle plate by one or more of welding, brazing, one or more mechanical fasteners and/or adhesive.

6. The combustor of claim 1 wherein the plurality of openings extend substantially parallel to a central axis of the at least one fuel nozzle.

7. The combustor of claim 1 wherein the plurality of openings are configured to direct the flow of diluent towards a plurality of airflow openings in the at least one fuel nozzle.

8. The combustor of claim 1 wherein the diluent comprises at least one of steam and/or nitrogen.

9. A method for providing diluent to a combustor comprising:
providing a plurality of openings disposed in a shroud affixed to a baffle plate and disposed between the baffle plate and at least one fuel nozzle extending through a through hole in the baffle plate; and
flowing the diluent through the plurality of openings toward at least one airflow opening in the at least one fuel nozzle.

10. The method of claim 9 comprising flowing the diluent along a flow channel defined by the shroud and an outer surface of the at least one fuel nozzle.

11. The method of claim 9 comprising flowing at least a portion of the diluent into at least one airflow opening in the at least one fuel nozzle.

12. The method of claim 11 comprising mixing the at least a portion of the diluent with an airflow entering the at least one airflow opening.

13. The method of claim 9 comprising sealing between the shroud and the at least one fuel nozzle thereby preventing diluent flow therebetween.

14. The method of claim 13 wherein the sealing between the shroud and the at least one fuel nozzle is accomplished via at least one piston ring disposed between the shroud and the at least one fuel nozzle.

15. The method of claim 9 wherein the diluent comprises at least one of steam and/or nitrogen.
